(19) United States
(12) Patent Application Publication
(10) Pub. No.: US 2017/0133709 A1
(43) Pub. Date: May 11, 2017

(54) LITHIUM-ION BATTERY AND METHOD FOR PRODUCING A LITHIUM-ION BATTERY

(71) Applicant: Lithium Energy and Power GmbH & Co. KG, Stuttgart (DE)

(72) Inventors: Hideki Masuda, Osaka (JP); Yudai Kawasoe, Kyoto (JP); Yutaro Katsumata, Kyoto (JP); Marcel Wilka, Kyoto (JP)

(21) Appl. No.: 15/344,733

(22) Filed: Nov. 7, 2016

(30) Foreign Application Priority Data
Nov. 5, 2015 (EP) 15193298.5

(51) Int. Cl. H01M 10/0525; C08K 3/04; H01M 10/44; H01M 10/0565; H01M 4/131; H01M 4/139; H01M 4/04; H01M 10/0587; C01G 53/00; H01M 4/62

(52) U.S. Cl. CPC H01M 10/0525; C01G 53/42; C08K 3/04; H01M 10/44; H01M 4/62; H01M 4/131; H01M 4/139; H01M 4/0404; H01M 10/0587; H01M 10/0565; C01P 2006/40; C08K 2201/001; H01M 2004/028

(57) ABSTRACT

A lithium-ion battery comprising at least one battery cell (2), the battery cell (2) in each case comprising a negative electrode (21), a positive electrode (22), an electrolyte composition (15), and a separator (18), characterized in that the lithium-ion battery further comprises at least one fast discharge device (61) and the surface of the negative and/or of the positive electrode (21, 22) is coated with a material which has an electrical resistance of more than 0 Ωcm² and a lithium-ion conductivity of more than 0 S/cm and which has a solubility of less than 1 g/L in the electrolyte composition (15) under the operating conditions of the lithium-ion battery.

### BACKGROUND OF THE INVENTION

A major part is increasingly being played in modern electrical devices by portability. A portable and powerful energy supply is expected not only of small electronic appliances such as portable telephones, navigation systems, etc. Motor vehicles as well are increasingly relying on a supply which is independent of fossil fuels. In view of the great weight of these appliances it is necessary not only to provide powerful batteries for these applications but also to reduce their weight.

In the years gone by, lithium-ion batteries have emerged in this field with particular promise, on account of their particularly high energy densities. Other advantages of lithium-ion batteries are that they exhibit virtually no memory effect and also that the self-discharge of the cell is comparatively low. Nevertheless, again and again, there are concerns confronting the use of these batteries, since erroneous usage, such as excessive charging or discharging, or a mechanical damage event, can result in uncontrolled production of heat (referred to as thermal runaway) or even fires or explosions. This represents a high safety risk, and consequently these batteries are limited in their use, in spite of their advantages, in sectors where safety is relevant, such as in air travel, for example.

Described in the prior art are various systems which are said to minimize the dangers originating from lithium-ion batteries. They include, in particular, protective circuits, which are able to reversibly interrupt current flow in the event of an unusual temperature increase, and safety valves, which are able to monitor the internal battery pressure and to interrupt discharge in an emergency. Also deserving of mention are the separators, which can separate the positive and negative electrodes irreversibly from one another, depending on the temperature. These measures are known to the skilled person.

It may nevertheless come to pass that, as a result of mechanical loading, there is damage in the lithium-ion batteries, causing a local short-circuit between the electrodes. This leads to severe local heating of the cell, which may be followed by fires and explosions.

### SUMMARY OF THE INVENTION

It is an object of this invention, therefore, to provide a lithium-ion battery in which the risk of a safety-critical heating of the cell in the event of mechanical damage to the cells, or of a local short-circuit between individual electrodes, can be effectively reduced. A further object of this invention is to provide a method by which a lithium-ion battery of this kind can be produced. These objects are achieved by the subjects of the present invention.

The present invention relates to a lithium-ion battery comprising at least one battery cell, the battery cell in each case comprising a negative electrode, a positive electrode, an electrolyte composition, and a separator, characterized in that the lithium-ion battery further comprises at least one fast discharge device and the surface of the negative and/or of the positive electrode is coated with a material which has an electrical resistance of more than 0 Ωcm² and a lithium-ion conductivity of more than 0 S/cm and which has a solubility of less than 1 g/L in the electrolyte composition under the operating conditions of the lithium-ion battery.

The fast discharge device of the invention is a device enabling the electrodes of a lithium-ion battery to be short-circuited over a very low resistance. The fast discharge device here preferably connects the positive and negative terminals of the battery cell or of the lithium-ion battery. The fast discharge device comprises an electrical component having a very low electrical resistance of 0.1 to 200 μΩ, preferably of 50 to 150 μΩ. In the event of critical behavior on the part of a battery cell or the lithium-ion battery (also referred to below as damage scenario), as for example when there is contact between the electrodes after damage to the cell(s) and/or to the separator, the fast discharge device is triggered. Very rapid activation is important here, since only in that way it is possible to prevent rapid heating of the cell as a result of uncontrolled discharge at the damage site.

Typical activation times of the fast discharge device of the invention are situated in a range from 0.01 to 500 ms, preferably in the range from 0.1 to 250 ms, as for example at 70 to 130 ms. Activation of the fast discharge device results in strong polarization of the electrodes and therefore in a sharp drop in voltage of the full cell to around 0 V. As a result of the very low short-circuit resistance of the fast discharge in comparison to the much higher damage zone resistance, only very low currents flow through the damage site. Together with the very low full-cell voltage, there is only a very slight warming locally. The fast discharge itself leads at the same time to overall heating of the defective cell or defective battery. The overall temperature in this case applies to a temperature of 100 to 200° C., preferably to a temperature of 130 to 170° C., more particularly to a temperature of 140 to 160° C. This leads to the separator shutting down, with shutdown occurring by the fusing of the separator pores as a result of the temperature increase, causing the separator to lose its ion conductivity. The shutdown of the separator occurs preferably within 1 to 60 seconds after the onset of the damage scenario, more particularly within 5 to 30 seconds. Accordingly, the shutdown of the lithium-ion battery is rapid. After the shutdown of the lithium-ion battery by the separator, the battery is in a virtually safe state, since no further electrochemical reactions can occur and hence no further current can flow.

In certain cases, however, this discharge may not take place completely, or not at the right time, or even a low damage site current results in severe local heating. This may be the case in particular with lithium-ion batteries having a high nickel content in the electrode material. Even in the case of low short-circuit currents, the local heating brought about as a result may cause a fire or an explosion. Therefore, although the fast discharge device increases the safety of lithium-ion batteries, it is not possible to convert every kind of cell into a completely safe cell by discharge. For this reason, the lithium-ion battery of the invention further comprises at least one electrode whose surface is coated with a material which has an electrical resistance of more than 0 Ωcm² and a lithium ion conductivity of more than 0 S/cm and which has a solubility of less than 1 g/L in the electrolyte composition under the operating conditions of the lithium-ion battery.

In one embodiment the invention relates to a lithium-ion battery wherein the coating material comprises at least one polymerizable material which, when a voltage is applied to the positive and/or negative electrodes of the lithium-ion battery, forms oligomeric and/or polymeric structures on the surface of the positive and/or negative electrode and so forms a coating layer which has a solubility of less than 1 g/L in the electrolyte composition under the operating conditions of the lithium-ion battery.

In a further embodiment, the invention relates to a lithium-ion battery wherein the at least one polymerizable material is selected from the compounds (1) to (16) defined in the description below, it being possible for these compounds to be used individually or in combination with one another.

In one embodiment the invention relates to a lithium-ion battery wherein the positive electrode comprises at least one positive active material which comprises a composite oxide comprising at least one metal selected from the group consisting of cobalt, magnesium, and nickel, and also lithium.

In one embodiment the invention relates to a lithium-ion battery wherein the positive active material comprises a compound of the formula LiNi₁₋ₓM′ₓO₂ with x≦0.5 and where M′ is selected from Co, Mn, Cr, and Al.

Another subject of the invention is a method for producing a lithium-ion battery comprising at least one fast discharge device and at least one battery cell, wherein the method comprises the following steps:

(a) coating the surface of a positive and/or negative electrode with a coating material which comprises at least one material which has a solubility in the electrolyte composition of less than 1 g/l at the lithium-ion battery operating temperature;
(b) joining together the optionally coated negative and positive electrodes obtained in step (a) with at least the further constituents of separator and electrolyte composition comprising at least one aprotic solvent and at least one lithium salt, so as to give a battery cell;
(c) joining together the battery cell obtained in step (b) with at least one fast discharge device and also, optionally, further battery cells, so as to obtain a lithium-ion battery;
(d) charging and discharging the resulting battery at least once so as to condition the lithium-ion battery.

In one embodiment the invention relates to a method of this kind for producing a lithium-ion battery wherein the electrolyte composition further comprises at least one electrolyte additive selected from the compounds (1) to (16) defined in the description.

A further subject of the invention is a method for producing a lithium-ion battery comprising at least one fast discharge device and at least one battery cell, wherein the method comprises the following steps:

(a) joining together the constituents of negative electrode, positive electrode, separator, and electrolyte composition, so as to give a battery cell, where the electrolyte composition comprises at least one electrolyte additive selected from the compounds (1) to (16) defined in the description;
(b) joining together the battery cell obtained in step (a) with at least one fast discharge device and also, optionally further battery cells so as to give a lithium-ion battery;
(c) charging and discharging the resulting battery at least once, so as to condition the lithium-ion battery and thus to form a coating layer on the surface of the positive and/or negative electrode, this layer comprising electrochemical reaction products of the compounds (1) to (16) added in step (a).

The invention also relates to a lithium-ion battery comprising at least one fast discharge device and at least one battery cell produced by one of the methods described.

Another subject of the invention is the use of an electrolyte composition comprising at least one aprotic solvent, at least one lithium salt, and at least one electrolyte additive selected from the compounds (1) to (16) defined in the description in a lithium-ion battery comprising at least one fast discharge device and at least one battery cell, the battery cell in each case comprising a negative electrode, a positive electrode, an electrolyte composition, and a separator.

The coating of the surfaces of the negative and/or positive electrodes reduces the risk of short-circuiting between the electrodes. If an electrode short-circuit nevertheless were to occur, the contact resistance between the electrodes is increased by the surface coating and hence the risk of uncontrolled heating of the lithium-ion battery is effectively reduced.

Furthermore, the diffusion resistance is increased for the positive and negative electrodes through the use of the coatings of the invention. This results in an increase in the electrode polarization during fast discharge. As a result, the full-cell voltage drop is intensified, resulting in a lower local heating.

A final, further advantage to be stated for the surface coating of the invention is that it results in the reactions between the electrodes and the electrolyte composition, which lead possibly to a very rapid and very strong local temperature increase in the lithium-ion battery, being shifted toward higher temperatures. Accordingly, the intrinsic safety relative to conventional lithium-ion batteries, which is inherent in the lithium-ion battery of the invention, is increased even without the fast discharge device.

Through the advantages of the invention as described it is possible in conjunction with the fast discharge device of the invention for even unsafe electrode materials, such as nickel-rich active materials, to be used more safely.

### BRIEF DESCRIPTION OF THE DRAWINGS

Working examples of the invention are elucidated in more detail below by means of drawings.

In the drawings:

FIG. 1 shows a diagrammatic representation of a battery cell,

FIG. 2 shows a diagrammatic representation of a short-circuit during a nail test, referred to as “nail penetration”,

FIG. 3 shows the change in the temperature and in the current flow of a lithium-ion battery of the invention during fast discharge and during the nail test,

FIG. 4 shows the voltage and flow characteristics of a lithium-ion battery with fast discharge device during fast discharge and during the nail test, without additional coating of the electrode.

### DETAILED DESCRIPTION

The constituents of the lithium-ion battery of the invention are described in detail hereinafter.

As positive electrode it is possible to use any positive electrode known to the skilled person and suitable for lithium-ion battery cells. In general a positive electrode comprises what is called a positive active material, which surrounds an electrically conducting material. Suitable electrically conducting material is any material having a conductivity of >10⁶ S/m at 25° C. Especially suitable are metals, and also their alloys. The electrically conducting material of the positive electrode is preferably aluminum. This material serves as a current collector.

The positive active material serves as the venue for the electrochemical reaction. Suitable materials are known to the skilled person. A review is provided by M. Yoshio and H. Noguchi in “Lithium-Ion Batteries—Science and Technologies”, M. Yoshio, R. J. Brodd, A. Kozawa (editors), chapter 2, pages 9 to 48; Springer Science+Business Media, LLC 2009. All positive active materials known to the skilled person are suitable for use for the purposes of the present invention. In particular the positive active material comprises lithiated intercalation compounds which are capable of reversibly accepting and releasing lithium ions. The positive active material may comprise a composite oxide which comprises at least one metal selected from the group consisting of cobalt, magnesium, nickel, and lithium.

More particularly it is possible to use lithium-containing compounds of the following formulae, which are described in EP 2 498 329 Al:

LiₐA_{1-b}R_{b}D₂ with 0.90≦a≦1.8 and 0≦b≦0.5; LiₐE_{1-b}R_{b}O_{2-c}D_{c} with 0.90≦a≦1.8, 0≦b≦0.5 and 0≦c≦0.05; LiE_{2-b}R_{b}O_{4-c}D_{c} with 0≦b≦0.5 and 0≦c≦0.05; LiₐNi_{1-b-c}Co_{b}R_{c}D_{α} with 0.90≦a≦1.8, 0≦b≦0.5, 0≦c≦0.05 and 0≦α≦2; LiₐNi_{1-b-c}Co_{b}R_{c}O_{2-α}Z_{-α}, with 0.90≦a≦1.8, 0≦b≦0.5, 0≦c≦0.05 and 0<α<2; LiₐNi_{1-b-c}Co_{b}R_{c}O_{2-α}Z₂ with 0.90≦a≦1.8, 0≦b≦0.5, 0≦c≦0.05 and 0<a<2; LiₐNi_{1-b-c}Mn_{b}R_{c}D_{α} with 0.90≦a≦1.8, 0≦b≦0.5, 0≦c≦0.05 and 0<α≦2; LiₐNi_{1-b-c}Mn_{b}R_{c}O_{2-α}Z_{α} with 0.90≦a≦1.8, 0≦b≦0.5, 0≦c≦0.05 and 0<α<2; LiₐNi_{1-b-c}Mn_{b}R_{c}O_{2-α}Z₂ with 0.90≦a≦1.8, 0≦b≦0.5, 0≦c≦0.05 and 0<α<2; LiₐNi_{b}E_{c}G_{d}O₂ with 0.90≦a≦1.8, 0≦b≦0.9, 0≦c≦0.5 and 0.001≦d≦0.1; LiₐNi_{b}Co_{c}Mn_{d}GₑO₂ with 0.90≦a≦1.8, 0≦b≦0.9, 0≦c≦0.5, 0≦d≦0.5 and 0.001≦e≦0.1; LiₐNiG_{b}O₂ with 0.90≦a≦1.8 and 0.001≦b≦0.1; LiₐCoG_{b}O₂ with 0.90≦a≦1.8 and 0.001≦b≦0.1; LiₐMnG_{b}O₂ with 0.90≦a≦1.8 and 0.001≦b≦0.1; LiₐMn₂G_{b}O₄ with 0.90≦a≦1.8 and 0.001≦b≦0.1; QO₂; QS₂; LiQS₂; V₂O₅; LiV₂O₅; LiTO₂; LiNiVO₄; Li_{(3-f)}J₂(PO₄)₃ with 0≦f≦2; Li_{(3-f)}Fe₂(PO₄)₃ with 0≦f≦2; and LiFePO₄.

In the formulae above A is selected from Ni, Co, Mn and combinations thereof; R is selected from Al, Ni, Co, Mn, Cr, Fe, Mg, Sr, V, a rare earth element and combinations thereof; D is selected from O, F, S, O and combinations thereof; E is selected from Co, Mn and combinations thereof; Z is selected from F, S, P and combinations thereof; G is selected from Al, Cr, Mn, Fe, Mg, La, Ce, Sr, V and combinations thereof; Q is selected from Ti, Mo, Mn and combinations thereof; T is selected from Cr, V, Fe, Sc, Y and combinations thereof; and J is selected from V, Cr, Mn, Co, Ni, Cu and combinations thereof.

One embodiment of the present invention comprises a positive active material comprising a compound of the formula LiMO₂, where M is selected from Co, Ni, Mn, Cr or mixtures of these and also mixtures of these with Al. In one preferred embodiment the positive active material is a material which comprises nickel, i.e. LiNi₁₋ₓM′ₓO₂, where M′ is selected from Co, Mn, Cr and Al and 0≦x<1. Examples include lithium nickel cobalt aluminum oxide cathodes (e.g. LiNi_{0.8}Co_{0.15}Al_{0.05}O₂; NCA) and lithium nickel manganese cobalt oxide cathodes (e.g. LiNi_{0.8}Mn_{0.1}Co_{0.1}O₂; NMC (811) or LiNi_{0.33}Mn_{0.33}CO_{0.33}O₂; NMC (111)). Particularly preferred are lithium cells with a high nickel fraction in the active material, very preferably cells comprising a positive active material which comprises a compound of the formula LiNi₁₋ₓM′ₓO₂ with x≦0.5 and where M′ is selected from Co, Mn, Cr and Al. Especially preferred are NCA and NMC (811), since they have proven to be extremely unsafe yet at the same time are also of particular interest for high-energy storage facilities, on account of their high specific capacity, and they therefore profit particularly from the technical effect of the invention. Additionally noteworthy as preferred positive active materials are superlithiated layered oxides, of which the skilled person is aware. Examples thereof are Li₁₊ₓMn_{2-y}M_{y}O₄ with x≦0.8, y<2; Li₁₊ₓCo_{1-y}M_{y}O₂ with x≦0.8, y<1; Li₁₊ₓNi_{1-y-z}Co_{y}M_{z}O₄ with x≦0.8, y<1, z<1 and y+z<1. In the aforementioned compounds, M may be selected from Al, Mg and/or Mn. Also deserving of particular mention as suitable positive active materials are Li₂MnO₃, Li_{1.17}Ni_{0.17}Co_{0.1}Mn_{0.56}O₂, LiCoO₂ and LiNiO₂.

Two or more of the positive active materials may in particular also be used in combination with one another. One preferred embodiment comprises, for example, compounds of the formula n(Li₂MnO₃): n−1(LiNi₁₋ₓM′ₓO₂) where M′ is selected from Co, Mn, Cr and Al and 0<n<1 and 0<x<1.

As further constituents, the positive active material may comprise, in particular, binders and electrically conducting additives. A review of suitable binders is provided by H. Yamamoto and H. Mori in “Lithium-Ion Batteries—Science and Technologies”, M. Yoshio, R. J. Brodd, A. Kozawa (editors), chapter 7, pages 163 to 180; Springer Science+Business Media, LLC 2009. Examples of binders include at least one compound selected form polyvinyl alcohol, carboxymethylcellulose, hydroxymethylcellulose, polyvinyl chloride, carboxylated polyvinyl chloride, polyvinyl fluoride, ethylene oxide-containing polymers, polyvinylpyrrolidone, polyurethane, polytetrafluoroethene, polyvinylidene fluoride, polyethylene, polypropylene, ethylene-propylene-diene terpolymer, styrene-butadiene copolymers, acrylonitrile-butadiene-styrene copolymers, epoxy resins, polyamides and the like. Binders deserving of emphasis as being preferred are, in particular, styrene-butadiene copolymer (SBR), polyvinylidene fluoride (PVdF), polytetrafluoroethene (PTFE) and ethylene-propylene-diene terpolymer (EPDM), especially polyvinylidene fluoride (PVdF) and polytetrafluoroethene (PTFE). A particularly noteworthy electrically conducting additive is carbon black (or acetylene black). The amount of binder and electrically conducting additives may account in each case for up to 15 wt % of the active material, preferably in each case 1 to 10 wt %.

The positive electrode may be produced by a process in which the positive active material is mixed with the electrically conducting additive and the binder and also where appropriate with a solvent (e.g., N-methylpyrrolidone) to form an active material composition which is then applied to the current collector. Processes of this kind are known to the skilled person and are therefore not described in any more detail here. The surface coverage of the current collector with the active material is 1 to 50 mg/cm², more particularly 5 to 20 mg/cm².

As negative electrode it is possible to use any negative electrode known to the skilled person and suitable for lithium-ion battery cells. In general a negative electrode comprises what is called a negative active material, which surrounds an electrically conducting material. Suitable electrically conducting material is any material that has a conductivity of >10⁶ S/m at 25° C. Especially suitable are metals, and also their alloys. The electrically conducting material of a negative electrode is preferably copper. This material serves as current collector.

The negative active material serves as the venue for the electrochemical reaction. Many suitable materials are described in the literature, among which anodes based on carbon in particular have become established, and especially the intercalation compounds of graphite, namely compounds which have a graphite structure and are suitable for intercalating and releasing lithium ions. Suitable materials are known to the skilled person. A review is provided by Z. Ogumi and H. Wang in “Lithium-Ion Batteries—Science and Technologies”, M. Yoshio, R. J. Brodd, A. Kozawa (editors), chapter 3, pages 49 to 74; Springer Science+Business Media, LLC 2009.

As further constituents the negative material may in particular comprise binders. A review of appropriate binders is provided by H. Yamamoto and H. Mori in “Lithium-Ion Batteries—Science and Technologies”, M. Yoshio, R. J. Brodd, A. Kozawa (editors), chapter 7, pages 163 to 180; Springer Science+Business Media, LLC 2009. Examples of binders include at least one compound selected form polyvinyl alcohol, carboxymethylcellulose, hydroxymethylcellulose, polyvinyl chloride, carboxylated polyvinyl chloride, polyvinyl fluoride, ethylene oxide-containing polymers, polyvinylpyrrolidone, polyurethane, polytetrafluoroethene, polyvinylidene fluoride, polyethylene, polypropylene, ethylene-propylene-diene terpolymer, styrene-butadiene copolymers, acrylonitrile-butadiene-styrene copolymers, epoxy resins, polyamides and the like. Binders deserving of emphasis as being preferred are, in particular, styrene-butadiene copolymer (SBR), polyvinylidene fluoride (PVdF), polytetrafluoroethene (PTFE) and ethylene-propylene-diene terpolymer (EPDM). The amount of binder may account for up to 15 wt % of the active material, preferably 1 to 10 wt %.

The negative electrode may be produced by a process in which the negative active material is mixed with the electrically conducting additive and with the binder and also where appropriate with a solvent (e.g., N-methylpyrrolidone) to form an active material composition which is then applied to the current collector. Processes of this kind are known to the skilled person and are therefore not described in any more detail here. The surface coverage of the current collector with the active material is 1 to 50 mg/cm², more particularly 5 to 20 mg/cm².

The function of the separator is to protect the electrodes from direct contact with one another and so to prevent a short circuit. At the same time the separator is required to ensure the transfer of the ions from one electrode to the other. It is therefore important that the separator is not electrically conductive, yet has as high as possible an ion conductivity, especially with respect to lithium ions.

Suitable materials are known to the skilled person. A review is provided by Z. Zhan and P. Ramadass in “Lithium-Ion Batteries—Science and Technologies”, M. Yoshio, R. J. Brodd, A. Kozawa (editors), chapter 20, pages 367 to 412; Springer Science+Business Media, LLC 2009.

A particular feature of suitable materials is that they are formed from an insulating material having a porous structure. Suitable materials are, in particular, polymers, such as polyolefins, polyesters, and fluorinated polymers. Particularly preferred polymers are polyethylene (PE), polypropylene (PP), polyethylene terephthalate (PET) polytetrafluoroethene (PTFE), and polyvinylidene fluoride (PVdF). In one embodiment the polymer or polymers used has/have a melting temperature in the range from 100° C. to 200° C., so that the pores in the separator can be sealed should the battery temperature increase too greatly (known as “separator shutdown”). Furthermore, the separator may comprise or consist of ceramic materials, provided that extensive lithium ion transfer is ensured. Particular materials include ceramics which comprise MgO, CuO or Al₂O₃. The separator may consist of one layer of one or more of the aforementioned materials, or else of two or more layers, in each of which one or more of the stated materials are combined with one another.

The thickness of the separator is preferably less than 50 μm, more particularly less than 25 μm. The pore size is preferably smaller than 2 μm, more particularly smaller than 1 μm and larger than 0.001 μm. A particularly preferred pore size range lies between 0.01 and 0.7 μm. In one preferred embodiment the separator has a porosity of at least 20% and not more than 60%. The electrical resistance is preferably at least 1 Ωcm², more particularly at least 2 Ωcm².

A suitable electrolyte composition is in principle any composition which permits transport of the positive charge from one electrode to the other electrode. This transport takes place customarily in the form of a lithium ion transport. Preference is therefore given to electrolytes which permit as far as possible unhindered transport of the lithium ions.

Suitable electrolyte compositions preferably comprise at least one anhydrous aprotic solvent and at least one salt. Suitable solvents are known to the skilled person. Used with preference is a mixture of at least one cyclic carbonate and at least one linear carbonate as solvent. Examples of cyclic carbonates include ethylene carbonate (EC), propylene carbonate (PC) and butylene carbonate (BC). Preferred linear carbonates are dimethylene carbonate (DMC), diethyl carbonate (DEC) and methyl ethyl carbonate (MEC). Particularly preferred is a solvent mixture comprising propylene carbonate and dimethyl carbonate. The solvent mixture comprises preferably 10 to 70 wt %, more preferably 20 to 50 wt %, of one or more cyclic carbonates, and 30 to 90 wt %, more preferably 50 to 80 wt %, of one or more linear carbonates, based on the total weight of the solvent mixture.

Suitable salts are all lithium salts which support the transfer of lithium ions between the electrodes. Examples included are preferably lithium hexafluorophosphate (LiPF₆), lithium tetrafluoroborate (LiBF₄), LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (where x and y independently of one another are integers from 1 to 20), LiCl, LiI, lithium bis(oxalato)borate (Li[B(C₂O₄)₂], LiBOB) and/or lithium difluoro(oxalato)borate (Li[BF₂(C₂O₄)], LiDFOB). They can be used individually or in combination with one another. The salt or salts in the electrolyte composition is or are used preferably in a concentration of 0.1 to 2.0 M. The electrolyte composition preferably has a lithium ion conductivity λ_{Li} in a range 0≦λ_{Li}≦20 mS/cm.

The electrolyte composition of the invention preferably comprises electrolyte additives which construct a layer of electrochemical reaction products such as oligomeric and/or polymeric units on the surface of the positive electrode and/or on the surface of the negative electrode when a voltage is applied to the electrodes. These products thus, together with the electrochemical reaction products of the other constituents of the electrolyte composition, form a coating layer of the invention.

Without being tied to the theory, it is assumed that carbonates such as propylene carbonate, ethylene carbonate and diethyl carbonate, for example, from the electrolyte composition are reduced on the electrode surface and form corresponding alkyl carbonates (cf. Kang Xu, Chem. Rev. 2004, 104, 4303-4417). There is also a reduction of the electrolyte additives. This has been investigated for various electrolyte additives, and, among others, the reduction of γ-butyrolactone to form polymeric structures (cf. Kang Xu, Chem. Rev. 2004, 104 4303-4417) and also the reduction of sulfur-containing electrolyte additives such as sultones and their reaction to form alkyl sulfonates have been observed (cf. K. Xu, Chem. Rev. 2014, 114, 11503-11618; B. Li et al.; Electrochimica Acta 2013, 105, 1-6).

The coating layer thus formed is characterized in that it has a high electrical resistance and at the same time possesses a high ion conductivity, especially with respect to lithium ions.

The level of electrical resistance of the coating layer, which is needed for the reliable operation of the lithium-ion battery, is dependent on the safety behavior of the lithium-ion battery in the event of damage, and also during fast discharge. The electrical resistance of the coating layer is greater than 0 Ωcm² and preferably has a value of ≧1 Ωcm², preferably ≧2 Ωcm², more particularly ≧3 Ωcm². A particularly preferred range comprises an electrical resistance of 10 to 1000 Ωcm².

The lithium ion conductivity σ_{Li} of the coating layer is greater than 0 S/cm. Preferably the lithium ion conductivity σ_{Li} of the coating layer is σ_{Li} of ≧10⁻¹⁵ S/cm, more preferably σ_{Li}≧10⁻¹² S/cm, and more particularly σ_{Li}≧10⁻¹⁰ S/cm.

Suitable electrolyte additives are set out below.

(1) Acyclic and cyclic carbonic esters of the general formulae (Ia) or (Ib):

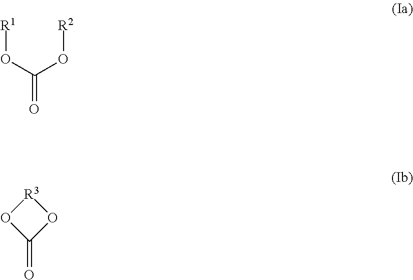

where R¹ and R² may be identical or different and are saturated or unsaturated, linear or branched hydrocarbon chains having 1 to 12 carbon atoms. Preferably R¹ and R² are linear hydrocarbon chains having 1 to 6 carbon atoms. At least one of the radicals, R¹ or R² is preferably unsaturated. More particularly R¹ and R² is a methyl, ethyl, propyl, butyl, pentyl or hexyl radical and its counterpart is a vinyl, allyl or propargyl radical. R³ is a saturated or unsaturated hydrocarbon radical having one to four carbon atoms, and R¹, R², and R³ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, and where adjacent hydrocarbon radicals may be connected to one another so as to form a ring. R³ is preferably a saturated or unsaturated hydrocarbon radical having two carbon atoms, which is substituted by at least one unsaturated hydrocarbon radical. Preferred halogen atoms are F, Cl, Br and I, more particularly F and Cl.

Specific examples of compounds of the formula (Ia) are vinyl methyl carbonate (VMC), vinyl ethylene carbonate (VEC), vinyl propyl carbonate, allyl methyl carbonate (AMC), allyl ethyl carbonate (AEC), allyl propyl carbonate, propargyl methyl carbonate (PMC), propargyl ethyl carbonate, propargyl propyl carbonate, and also asymmetric dialkyl carbonates such as methyl n-propylcarbonate, methyl-isopropyl carbonate, ethyl n-propyl carbonate and ethyl isopropyl carbonate.

Specific examples of compounds of the formula (Ib) are ethylene carbonate, methylethylene carbonate, dim ethyl ethylene carbonate, phenylethylene carbonate (PhEC), vinylene carbonate (VC), phenylvinylene carbonate (PhVC), vinylethylene carbonate, allylethylene carbonate, propargylethylene carbonate, and pyrocatechol carbonate.

Specific examples of halogen derivatives of the cyclic and acyclic carbonic esters described are chloroethylene carbonate (ClEV), fluoroethylene carbonate (FEC), trifluoropropylene carbonate (TFPC), trifluoromethylpropylene carbonate.

(2) Polycyclic aromatic hydrocarbons having 9 to 30 carbon atoms, such as biphenyl (BP), o-terphenyl (OTP), m-terphenyl, p-terphenyl, bibenzyl (DBZ), indene, fluorine, naphthalene, anthracene, benzopyrene, acenaphthylene, acenaphthene, phenanthrene, fluoanthene, pyrene, benzanthracene, coronene, tetracene, pentacene and chrysene. Particularly preferred are polycyclic aromatic hydrocarbons having 12 to 24 carbon atoms, especially biphenyl (BP), o-terphenyl (OTP) and bibenzyl (DBZ). The group of the polycyclic aromatic hydrocarbons also embraces compounds in which the aromatic rings are separated from one another by heteroatoms such as oxygen or nitrogen, an example being diphenyl ether (DPE).

Preferred from this group are biphenyl (BP), o-terphenyl (OTP), bibenzyl (DBZ), and diphenyl ether (DPE). Especially preferred is biphenyl (BP).

(3) Heterocyclic aromatic compounds of the formula (II):

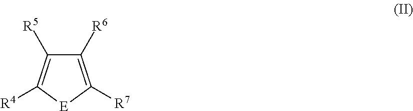

where E is an element selected from the group consisting of O, S, and NR⁸, R⁴ to R⁷ are each a hydrogen atom, a halogen atom, a cyano group, a saturated or unsaturated hydrocarbon radical having 1 to 6 carbon atoms, which may be substituted by halogen atoms, or a saturated or unsaturated alcoxy radical having 1 to 6 carbon atoms, which may be substituted by halogen atoms, where adjacent radicals R⁴ and R⁵, R⁵ and R⁶, R⁶ and R⁷ may be connected to one another so as to form a ring, and R⁸ is a hydrogen atom or a saturated or unsaturated, linear or branched hydrocarbon radical having 1 to 6 carbon atoms, which may be substituted by halogen atoms. Preferred halogen atoms are F, Cl, Br and I, especially F and Cl. The radicals R⁴ to R⁷ are preferably selected from a hydrogen atom, a cyano group, a chlorine atom, a fluorine atom, a saturated hydrocarbon radical having 1 to 3 carbon atoms, or a saturated alcoxy radical having 1 to 3 carbon atoms.

Examples of compounds of the formula (II) are furan, 2-cyanofuran, thiophene, N-alkylpyrrol, especially N-methylpyrrol and N-ethylpyrrol. Preferred bicyclic compounds of the formula (II) include 3,4-ethylenedioxythiophene (EDT).

(4) Pyridine and pyridine derivatives of the formula (III):

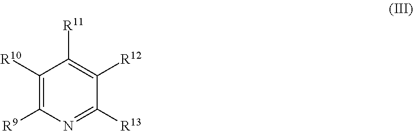

where R⁹ to R¹³ independently of one another may be selected from a hydrogen atom, a halogen atom, saturated or unsaturated, linear or branched hydrocarbon radicals having 1 to 6 carbon atoms, and cyclic, saturated or unsaturated hydrocarbon radicals having 3 to 12 carbon atoms, where adjacent hydrocarbon radicals may be connected to one another so as to form a ring. The radicals R⁹ to R¹³ are preferably selected from a hydrogen atom, an unsaturated, unbranched hydrocarbon radical having 2 to 4 carbon atoms or a cyclic, unsaturated hydrocarbon radical having 6 to 9 carbon atoms. Preferred halogen atoms are F, Cl, Br and I, especially F and Cl.

Specific examples of compounds of the formula (III) are pyridine, 2-vinylpyridine and 2, 2′-bipyridine. Particularly preferred is 2-vinylpyridine.

(5) Acyclic and cyclic sulfites of the general formulae (IVa) and (IVb):

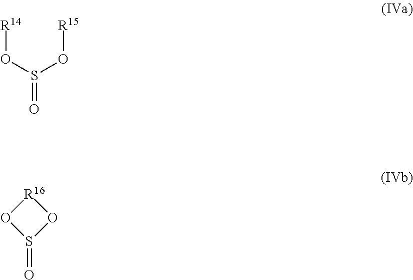

where R¹⁴ to R¹⁵ may be identical or different and are saturated or unsaturated, linear or branched hydrocarbon chains having 1 to 6 carbon atoms. Preferably R¹⁴ and R¹⁵ are linear hydrocarbon chains. At least one of the radicals R¹⁴ and R¹⁵ is preferably unsaturated. More particularly R¹⁴ or R¹⁵ is a methyl, ethyl, propyl, butyl, pentyl or hexyl radical and the other of the radicals is a vinyl, allyl or propargyl radical. R¹⁶ is a saturated or unsaturated hydrocarbon radical having one to four carbon atoms. R¹⁴, R¹⁵ and R¹⁶ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, where adjacent hydrocarbon radicals may be connected to one another so as to form a ring. R¹⁶ is preferably a saturated or unsaturated hydrocarbon radical having 2 or 3 carbon atoms. Preferred halogen atoms are F, Cl, Br and I, especially F and Cl.

Specific examples of compounds of the formula (IIIa) are dimethyl sulfite, diethyl sulfite, dipropyl sulfite, dibutyl sulfite, dipentyl sulfite and dihexyl sulfite. Particularly preferred are dimethyl sulfite and diethyl sulfite.

Specific examples of compounds of the formula (IIIb) are ethylene sulfite, propylene sulfite, butylene sulfite, vinylethylene sulfite, phenylethylene sulfite, phenylvinylene sulfite. Particularly preferred are ethylene sulfite and propylene sulfite.

(6) Sulfonic esters of the general formula (V):

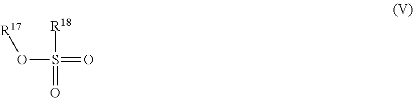

where R¹⁷ and R¹⁸ independently of one another are linear or branched, saturated or unsaturated hydrocarbon chains having 1 to 6 carbon atoms, which may optionally be substituted by halogen atoms or haloalkanes having 1 to 5 carbon atoms. Preferred halogen atoms are F, Cl, Br and I, especially F and Cl. Preferred haloalkanes are —CF₃ and —CCl₃. In one preferred embodiment, R¹⁷ and R¹⁸ are connected to one another so as to form a ring. Especially preferred are compounds of the formula (V) in which the radicals R′⁷ and R¹⁸ are connected and form a ring consisting of three carbon atoms and also the O and S atom attached thereto. Particularly preferred embodiments are sultones, more particularly 1,3-propane sultone, 1,3-propene sultone, 1,5-butane sultone, 1,4-butene sultone, and also their halogen derivatives, especially fluoropropane sultones.

(7) Sulfuric esters of the general formula (VI):

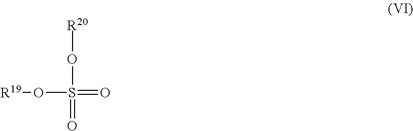

where R¹⁹ and R²⁰ independently of one another are linear or branched, saturated or unsaturated hydrocarbon chains having 1 to 6 carbon atoms, which may optionally be substituted by halogen atoms. In one preferred embodiment, R¹⁹ and R²⁰ are connected to one another so as to form a ring. Preferred halogen atoms are F, Cl, Br and I, especially F and Cl.

Particularly preferred compounds of the formula (IV) are allyl methylsulfonate (AMS), allylethylsulfonate, propargyl methylsulfonate (PMS), propargyl ethylsulfonate and 1,3,2-dioxathiolane 2,2-dioxide (DTD).

(8) Cyclic carboxylic acid derivatives of the formula (VII):

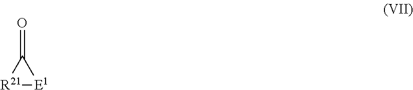

where E¹ is O or NR²⁴, R²¹ is a hydrocarbon radical having 1 to 5 carbon atoms or a group of the formula —R²²—C(O)-E²-R²³—, where R²² and R²³ each independently of one another are a hydrocarbon group having 1 to 2 carbon atoms, E² is O or NR²⁴, and each R²⁴ independently of any other is a hydrogen atom, a linear or branched, saturated or unsaturated hydrocarbon radical having 1 to 6 carbon atoms, which may optionally be substituted by halogen atoms, hydrocarbon radicals having 1 to 6 carbon atoms or radicals of the formula —C(O)R²⁵, where R²⁵ is a linear or branched, saturated or unsaturated hydrocarbon radical having 1 to 6 carbon atoms. Preferred halogen atoms are F, Cl, Br and I, especially F and Br.

Specific examples of compounds of the formula (VII) with E¹=O are lactones, such as alpha-, beta-, gamma-, delta- and epsilon-lactones, and also their halogen derivatives. Preferred among these is gamma-lactone, more particularly gamma-butyrolactone, and also derivatives thereof, more particularly halogen derivatives such as α-fluoro-γ-butyrolactone, α-bromo-γ-butyrolactone, β-bromo-γ-butyrolactone, β-fluoro-γ-butyrolactone, γ-bromo-γ-butyrolactone, γ-fluoro-γ-butyrolactone.

Examples of compounds of the formula (VII) with E¹=NR²⁴ are lactams such as alpha-, beta-, gamma-, delta- and epsilon-lactam, and also their halogen derivatives, N-alkyl lactams and N-acetyl lactams. One particularly preferred embodiment is N-acetylcaprolactam.

Specific examples of compounds of the formula (VII) with E¹=O and R²¹═—R²²—C(O)-E²-R²³— include glycolide and its derivatives substituted by hydrocarbon radicals having 1 to 6 carbon atoms, more particularly glycolide (dimer of hydroxyacetic acid), dimethylglycolide and tetramethylglycolide.

(9) Acyclic unsaturated carboxylic acid derivatives of the general formula (VIII)

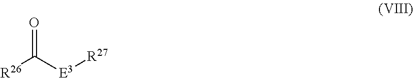

where R²⁶ is hydrogen, a halogen atom or a saturated or unsaturated, aromatic or aliphatic, linear or branched hydrocarbon radical having 1 to 12 carbon atoms, which may be substituted by halogen atoms, and R²⁷ is a saturated or unsaturated, linear or branched hydrocarbon radical having 1 to 12 carbon atoms, and E³ is O or NR²⁸, and R²⁸ and R²⁷ independently of one another have the same definition. Preferred halogen atoms are F, Cl, Br and I, especially F and Cl. If R²⁶ is an aromatic radical, then R²⁷ is preferably a saturated, linear or branched hydrocarbon radical having 1 to 6 carbon atoms. If R²⁶ is an aliphatic hydrocarbon radical, then R²⁷ is preferably a vinyl, allyl or propargyl radical. With particular preference the compounds of the formula (VII) are carboxylic esters, more particularly vinyl acetate (VA), methyl chloroformate, methyl benzoate and methyl cinnamate, and also carboxamides, more particularly N—N-di methyltrifluoroacetamide (DTA), N—N-dimethylacetamide and N,N-diethyltrifluoroacetamide.

(10) Carboxylic anhydrides and carboximides of the formulae (IXa) and (IXb):

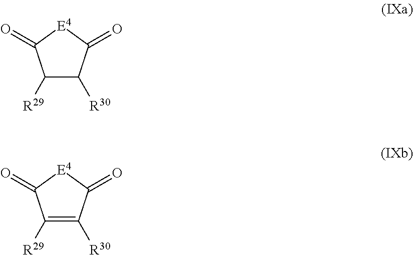

where E⁴ has the definition of O or NR³¹, R²⁹ and R³⁰ may be selected independently of one another from hydrogen atoms, halogen atoms and linear or branched, saturated or unsaturated hydrocarbon radicals having 1 to 6 carbon atoms, which may optionally be substituted by halogen atoms. In one preferred embodiment, R²⁹ and R³⁰ are connected to one another so as to form a ring. R³¹ is a hydrogen atom or a linear or branched, saturated or unsaturated hydrocarbon radical having 1 to 6 carbon atoms. Preferred halogen atoms are F, Cl, Br and I, especially F and Cl.

Specific examples of compounds of formula (IXa) are succinic anhydride, maleic anhydride, succinimide and maleimide. Specific examples of compounds of the formula (IXb) are phthalic anhydride and phthalimide.

(11) Compounds of the formula (X)

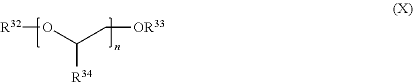

where n is an integer from 1 to 10, R³² and R³³ independently of one another are a linear or branched, saturated or unsaturated hydrocarbon radical having 1 to 6 carbon atoms, and R³⁴ is a methyl radical, an ethyl radical, an n-propyl radical or an isopropyl radical. Particularly preferred is tetra(ethylene glycol) dimethyl ether (TEGME).

(12) Organic nitriles of the formula (XI):

R³⁵—CN (XI)

where R³⁵ is a linear, saturated or unsaturated hydrocarbon radical having 1 to 6 carbon atoms, which may optionally be substituted by at least one cyano group. Preferred embodiments are acetonitrile (AN) and adiponitrile (ADN).

(13) Organic phosphates of the formula (XII):

(O)P(OR³⁶)(OR³⁷)(OR³⁸) (XII)

where R³⁶ to R³⁸ independently of one another are aliphatic or aromatic hydrocarbon radicals having 1 to 6 carbon atoms, which may optionally be substituted by one or more halogen atoms. Preferred halogen atoms are F, Cl, Br and I, especially F and Cl. One preferred embodiment is tris(2,2,2-trifluoroethyl) phosphate (TTFP).

(14) Organic borates of the formula (XIII):

Mt[B(OR³⁹)(OR⁴⁰)(OR⁴¹)(OR⁴²)] (XIII)

where Mt is a monovalent metal cation, preferably lithium, and R³⁹ to R⁴² independently of one another are aliphatic or aromatic hydrocarbon radicals having 1 to 6 carbon atoms, which may optionally be substituted by one or more halogen atoms, or are carbonyl groups having 1 to 6 carbon atoms, which may optionally be substituted by one or more halogen atoms. Preferred halogen atoms are F, Cl, Br and I, especially F and Cl. Preferably two each of the radicals R³⁹ to R⁴² are connected to one another so as to form a ring. Preferred embodiments are lithium bis(oxalato)borate (LiBOB) and lithium difluoro(oxalato)borate (LiDFOB).

(15) Organic dialkyl dicarbonates of the formula (XIV):

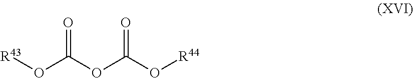

where R⁴³ and R⁴⁴ independently of one another may be selected from linear or cyclic, saturated or unsaturated hydrocarbon radicals having 1 to 6 carbon atoms.

(16) Inorganic compounds of the formulae CO₂, N₂O, SO₂, CS₂, and Sₓ²⁻ (more particularly S₈²⁻),

All aforesaid electrolyte additives may be used individually or in combination with one another.

Of the aforementioned electrolyte additives, especially preferred are sultones, lactones and polycyclic aromatic hydrocarbons. Sultones here form a coating layer of the invention on the negative electrode in particular, while lactones and polycyclic aromatic hydrocarbons form such a layer on the positive electrode.

The lithium-ion battery of the invention further comprises a fast discharge device. This device, in the event of damage, such as when a battery cell suffers damage, for example, allows the voltage in the cell or battery to be minimized within a short time, and allows the local heating during a short circuit to be kept as low as possible. A feature of the fast discharge device is that it comprises an electrical component having an electrical resistance of 0.1 to 200 μΩ, preferably of 50 to 150 μΩ. The fast discharge device is arranged in such a way that it is able to connect the negative and positive electrodes of a battery cell to one another, preferably at the terminals of the electrodes.

A feature of the lithium-ion battery of the invention is that the negative and/or positive electrode is coated with a material which leads to an increase in the electrical contact resistance of the electrodes while nevertheless exhibiting good ion conductivity. By means of such a layer it is possible to reduce the risk of a short circuit even in the event of mechanical damage to the separator.

The coating layer preferably has a thickness of ≦50 μm, more particularly of ≦25 μm. The electrical resistance of the coating layer is greater than 0 Ωcm² and preferably has a value of ≧1 Ωcm², more preferably ≧2 Ωcm², more particularly ≧3 Ωcm². The ion conductivity of the electrolyte and/or of the surface coating layer is generally dependent on the safety characteristics of the lithium-ion battery during fast discharge or the damage scenario. A lithium ion conductivity σ_{Li} of the coating layer is greater than 0 S/cm. Preferably the lithium ion conductivity σ_{Li} of the coating layer is σ_{Li}≧10⁻¹⁵ S/cm, more preferably σ_{Li}≧10⁻¹² S/cm and more particularly σ_{Li}≧10⁻¹⁰ S/cm.

The coating layer consists of a material which in the electrolyte composition used, under the operating conditions of the lithium-ion battery, has a solubility of less than 1 g/L, preferably of less than 0.5 g/L, more particularly of less than 0.1 g/L. Operating conditions of the lithium-ion battery encompass a temperature of −50° C. to 100° C., preferably −20° C. to 70° C.

In one embodiment of the invention the coating is obtained by coating the electrodes with the appropriate material on the surface of the positive and/or negative active material before the lithium-ion batteries are assembled.

Suitable materials are both organic and inorganic coating materials, provided that they meet the stated conditions concerning the solubility, the electrical conductivity and the lithium ion conductivity. Organic coatings include, in particular, polymers such as polyolefins and polyesters. Especially preferred are coatings comprising polyethylene, polypropylene, polyethylene terephthalate, polyvinyl fluorides and polytetrafluoroethene. Suitable inorganic coating materials are not subject to any particular restriction, provided that they meet the stated conditions concerning the solubility, the electrical conductivity and the lithium ion conductivity. Examples include, in particular, inorganic ceramics, non-electronically conducting metal oxides and metal phosphates, and lithium salts. Especially suitable are coatings comprising AlPO₄, Al₂O₃, ZrO₂, SiO₂, LiF, Li₂O, Li₂CO₃ and AlF₃, and also mixtures thereof.

The materials may be applied to the surface of the active materials using all of the coating methods that are known to the skilled person. These include dip coating, roll coating, rod coating, brush coating, spray coating, knife coating, flow coating, rotational coating or slot coating. Spray coating is particularly suitable, especially as applied to solutions of the materials or suspensions, especially of nanoparticles of undissolved material. Further preferred, particularly for polymeric materials, is rotational coating (spin coating).

In a further embodiment of the present invention, the coating layer is formed from electrochemical reaction products of the aforementioned electrolyte additives (1) to (16). They can be reacted individually or in combination with one another with the surface of the positive and/or negative active material. The reaction may be carried out before or after the assembly of the lithium-ion battery. If the reaction is carried out prior to assembly, i.e., before the constituents of the lithium-ion battery are joined together, then the respective electrode is immersed in a solution which comprises the desired electrolyte additive or additives, and a voltage is applied. After the end of the reaction, the coated electrode is optionally cleaned, dried and/or sintered and in that form can be installed in the lithium-ion battery. Purification can be accomplished by rinsing with an aprotic solvent, more particularly with the electrolyte solvent to be used. The drying step may take place at a temperature of 70° C. to 150° C. The sintering may take place at a temperature of 150° C. to 500° C., more particularly at 175° C. to 300° C. The dipping solution preferably comprises the same solvent or solvents as the electrolyte composition which is subsequently employed in the lithium-ion battery. In that case there is generally no need for the washing, drying and/or sintering.

In one preferred embodiment, the electrochemical coating reaction is carried out in the ready-assembled lithium-ion battery. For this purpose the constituents of the battery cell are assembled in a conventional way, with the fast discharge device being arranged such that it connects the negative and the positive electrode(s) of the lithium-ion battery to one another. The electrolyte composition used is a composition which comprises at least one of the electrolyte additives (1) to (16). The battery cell is subsequently charged for first use in a manner known to the skilled person, and held in the charged state for 1 to 10 hours. After that time the battery can be discharged and the charging cycle may optionally be repeated 1 to 5 times. This process forms what is called a “solid electrolyte interface” (SEI) on the surfaces of the electrodes, comprising electrochemical reaction products of the electrolyte additives (1) to (16) and also, optionally, electrochemical reaction products of the other constituents of the electrolyte composition. Through the addition of the electrolyte additives an SEI is obtained in this way that corresponds to the desired properties, specifically (i) having a high electrical resistance and (ii) possessing good ion conductivity with respect to lithium ions. This process corresponds to the formation of the lithium-ion battery. This is the term the skilled person uses to refer to the first-time passage of a lithium-ion battery through a defined charging/discharging sequence. Formation is carried out preferably at a temperature of 0 to 70° C., more particularly at 15 to 50° C. The lithium-ion battery is typically charged initially with low current flow, which is later increased. The cell voltage of the charged lithium-ion battery is measured and the battery is stored for a period as specified. Measuring the cell voltage is used to reveal defective batteries.

Particularly suitable SEIs for the negative electrode include oligomeric and/or polymeric structures, formed from sultones, such as 1,3-propane sultone (PS), 1,3-propene sultone, 1,4-butane sultone, 1,4-butene sultone and fluoropropane sultone. Particularly suitable SEIs for the positive electrode include oligomeric and/or polymeric structures which are formed from γ-butyrolactone and/or biphenyl. The formation may be carried out accordingly for each electrode separately in an electrolyte composition comprising the desired electrolyte additives.

In one preferred embodiment, the lithium-ion battery, prior to formation, is assembled in a way such that each battery cell consists of a positive electrode, a negative electrode and a separator arranged in-between, the constituents entering uniformly into contact with the electrolyte composition. Furthermore, each cell may comprise a fast discharge device. Where, however, the lithium-ion battery of the invention (i.e., battery pack comprising at least one battery cell and at least one fast discharge device) is formed from a multiplicity of individual battery cells, there is no need to provide a fast discharge device for each of the battery cells. Preferably, therefore, a lithium-ion battery of the invention comprises fewer fast discharge devices than battery cells. In general one fast discharge device per lithium-ion battery is sufficient in order to discharge the battery cells of the battery.

The methods for the coating of the electrode surfaces may optionally be combined with one another; in other words, before the assembly of the battery cells, the electrodes may first of all be provided with a coating layer, which is subsequently supplemented in the assembled battery cell by an electrochemical reaction using the electrolyte additives (1) to (16) with an SEI.

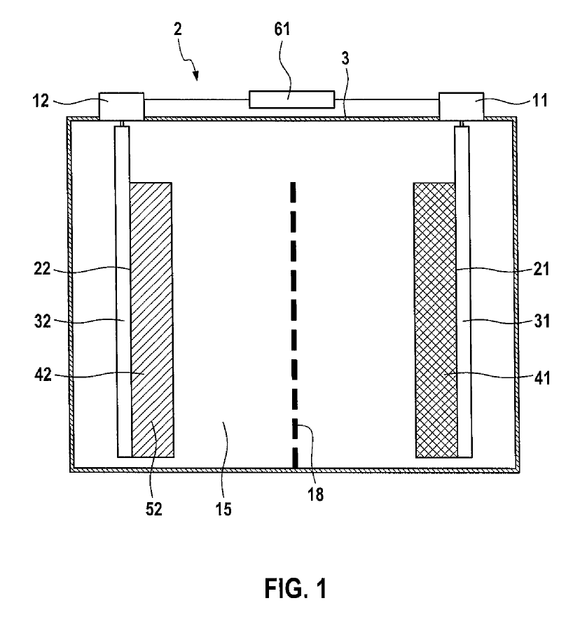

In FIG. 1, a battery cell 2 is shown diagrammatically. The battery cell 2 comprises a cell casing 3, which is prismatic in form, cuboidal in the present case. The cell casing 3 is presently of electrically conducting configuration and is manufactured, for example, from aluminum. The cell casing 3 may alternatively be manufactured from an electrically insulating material, such as plastic, for example.

The battery cell 2 comprises a negative terminal 11 and a positive terminal 12. A voltage made available by the battery cell 2 can be tapped via the terminals 11, 12. Furthermore, the battery cell 2 may also be charged via the terminals 11, 12. The terminals 11, 12 are arranged at a distance from one another on an outer surface of the prismatic cell casing 3.

The terminals 11, 12 are connected to one another via the fast discharge device 62. The fast discharge device 62 is characterized in that it has a low electrical resistance, of 100 μΩ, for example.

Disposed within the cell casing 3 of the battery cell 2 is an electrode spiral which has two electrodes, a negative electrode 21 and a positive electrode 22. The negative electrode 21 and the positive electrode 22 are each of foil-like construction, and are wound to form the electrode spiral with a separator 18 in between. It is also conceivable for a plurality of electrode spirals to be provided in the cell casing 3. Instead of the electrode spiral it is also possible, for example, for an electrode stack to be provided.

The negative electrode 21 comprises a negative active material 41 which is of foil-like configuration. The base material of the negative active material 41 is silicon or a silicon-containing alloy.

The negative electrode 21 further comprises a current collector 31, which is likewise of foil-like construction. The negative active material 41 and the current collector 31 are laid flatly against one another and connected to one another. The current collector 31 of the negative electrode 21 is of electrically conductive design and is fabricated from a metal, such as from copper, for example. The current collector 31 of the negative electrode 21 is connected electrically to the negative terminal 11 of the battery cell 2.

The positive electrode 22 is presently an HE (high-energy) NCM (nickel-cobalt-manganese) electrode. The positive electrode 22 comprises a positive active material 42, which is present in particle form. Arranged between the particles of the positive active material 42 are additives, especially conductive carbon black and binder. The positive active material 42 and the stated additives here form an integrated system which is of foil-like configuration.

The positive electrode 22 further comprises a current collector 32, which is likewise of foil-like construction. The assembly of the positive active material 42 and the additives and the current collector 32 are laid flatly against one another and connected to one another. The current collector 32 of the positive electrode 22 is of electrically conductive design and is fabricated from a metal, such as from aluminum, for example. The current collector 32 of the positive electrode 22 is connected electrically to the positive terminal 12 of the battery cell 2.

The negative electrode 21 and the positive electrode 22 are separated from one another by the separator 18. The separator 18 is likewise foil-like in design. The separator 18 is of electronically insulating design, but is ionically conductive, thus being pervious to lithium ions.

Applied to the particles of the positive active material 42 is a coating 52. The particles of the positive active material 42 are surrounded by the coating 52. The coating 52 therefore envelopes the particles of the positive active material 42.

The coating 52 presently comprises a polymer layer which has been formed during formation from the monomeric 3-propene sultone (PSR) present in the electrolyte composition. The coating 52 prevents or reduces contact between the positive active material 42 and the electrolyte composition 15 contained in the cell casing 3 of the battery cell 2.

The cell casing 3 of the battery cell 2 is filled with a liquid aprotic electrolyte composition 15. This electrolyte composition 15 surrounds the negative electrode 21, the positive electrode 22 and the separator 18. The electrolyte composition 15 is also ionically conductive. The electrolyte composition optionally comprises at least one of the above-defined compounds (1) to (16). Presently, for example, it comprises 3-propene sultone in a concentration of 2 wt %, based on the overall amount of electrolyte.

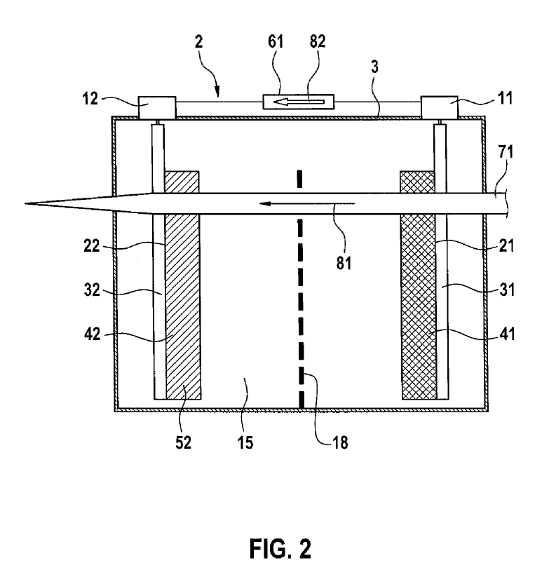

FIG. 2 shows, diagrammatically, the battery cell 2 from FIG. 1 in the damage scenario known as nail penetration, i.e. the penetration of the battery cell 2 by a nail 71. As the result of the nail 71, which also penetrates the separator 18, a damage zone current 81 is able to flow from the negative electrode 21 to the positive electrode 22. This may result in severe local heating in the region of the damage site. It is also possible for there to be direct contact between the negative electrode 21 and the positive electrode 22. If the electrical resistance of the triggered fast discharge device 61 is lower than that of the damage site, a major part of the current flows as fast discharge current 82. There is fast discharge of the battery cell 2 and at the same time an overall heating which triggers the sealing of the separator. In the damage scenario, the coating 52 further reduces the contact of the electrodes 21 and 22 with one another and/or with the nail 71. Hence the flow of a damage zone current 81 is further reduced or prevented entirely. The risk of thermal runaway of the battery cell 2 is prevented or reduced.

The invention is not confined to the working examples described here and to the aspects emphasized therein. Instead, within the region indicated by the claims, a host of modifications are possible which are within the scope of activity of the skilled person.

### Working Example

Two lithium-ion batteries are produced, having the following characteristic data:

Positive electrode:

Active material: LiNi_{0.8}Co_{0.15}Al_{0.05}O₂ (NCA)

Binder: about 3 wt %, based on the total amount of active material

Electrically conducting material: carbon black, about 3% based on the total amount of active material

Surface coverage: about 20 mg/cm²

Negative electrode:

Active material: graphite

Binder: about 3 wt %, based on the total amount of active material

Surface coverage: about 15 mg/cm²

Separator:

Thickness: about 20 μm with ceramic coating

Pretreatment and formation:

Precharge to about 10% state of charge (SOC) Formation:

2 cycles (charging and discharging) with 0.2 C, voltage limits 2.5-4.35 V

1 cycle with 1 C, voltage limits 2.5-4.35 V

One of these cells serves as a comparison cell. In this cell, the electrolyte composition used was a 1.2 M solution of LiPF₆ in a mixed solvent composed of ethylene carbonate (EC):dimethyl carbonate (DMC):ethyl methyl carbonate (EMC) in a ratio of 25:20:55.

In the other, inventive cell, the electrolyte composition used was a 1.2 M solution of LiPF₆ in a mixed solvent composed of fluoroethylene carbonate (FEC):dimethyl carbonate (DMC) in a ratio of 90:10, to which additionally 2 wt % of 1,3-propene sultone (PRS) was admixed, based on the total amount of electrolyte. Both cells were assembled and subsequently charged as specified.

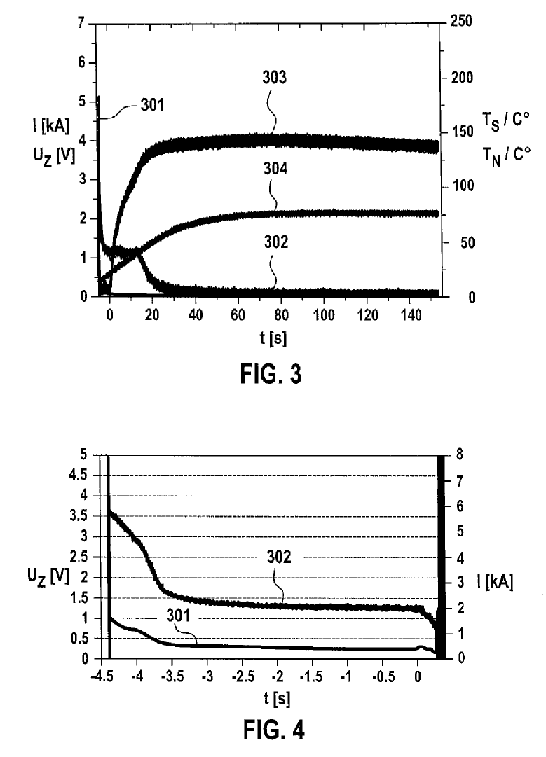

A nail penetration test was carried out with both cells. The results of measurement can be seen in FIG. 3 (inventive lithium-ion battery) and FIG. 4 (comparison battery).

FIG. 3 here shows the change in the nail temperature 303 (T_{N} in ° C.) and the surface temperature 304 (T_{S} in ° C.). Also shown is the change in the current strength 302 (I in kA) and in the cell voltage 301 (U_{Z} in V) of the lithium-ion battery (positive electrode active material: NAC; 1,3-propene sultone as additive) during fast discharge and nail penetration. In evidence are the activation of the fast discharge (at t=−4.5 seconds), the nail penetration (at t=0 seconds) and the shutdown of the separator (at t=20 seconds).

FIG. 4 shows the voltage and current characteristics (current strength 302 (I in kA) and cell voltage 301 (U_{Z} in V)) of a lithium-ion battery without coating (positive electrode active material: NAC; no additive) during fast discharge and nail penetration. In evidence are the activation of the fast discharge (at t=−4.5 seconds), the nail penetration (at t=0 seconds) and the hazard event (at t=0.3 seconds).

As can be seen, a low level of cell heating occurred in the case of the inventive lithium-ion battery, and was ended by the closing of the separator. There was no hazard event. In contrast, in the case of the comparison cell without the inventive coating, the hazard event occurred just 0.3 seconds after nail penetration.

1. A lithium-ion battery comprising at least one battery cell (2), the battery cell (2) in each case comprising a negative electrode (21), a positive electrode (22), an electrolyte composition (15), a separator (18), and at least one fast discharge device (61), wherein a surface of the negative and/or of the positive electrode (21, 22) is coated with a material which has an electrical resistance of more than 0 Ωcm² and a lithium-ion conductivity of more than 0 S/cm and which has a solubility of less than 1 g/L in the electrolyte composition (15) under operating conditions of the lithium-ion battery.

2. The lithium-ion battery of claim 1, wherein the coating material comprises at least one polymerizable material which, when a voltage is applied to the positive and/or negative electrodes (22, 21) of the lithium-ion battery, forms oligomeric and/or polymeric structures on the surface of the positive and/or negative electrode (22, 21) and so forms a coating layer which has a solubility of less than 1 g/L in the electrolyte composition (15) under the operating conditions of the lithium-ion battery.

3. The lithium-ion battery of claim 2, wherein the at least one polymerizable material is selected from the following compounds (1) to (16):
(1) acyclic and cyclic carbonic esters of the general formulae (Ia) or (Ib): 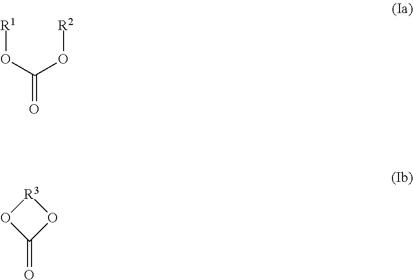
where R¹ and R² may be identical or different and are saturated or unsaturated, linear or branched hydrocarbon chains having 1 to 12 carbon atoms, R³ is a saturated or unsaturated hydrocarbon radical having one to four carbon atoms, and R¹, R², and R³ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, and where adjacent hydrocarbon radicals may be connected to one another so as to form a ring;
(2) polycyclic aromatic hydrocarbons having 9 to 30 carbon atoms, where individual aromatic rings may be connected by heteroatoms selected from O, S, and N;
(3) heterocyclic aromatic compounds of the formula (II): 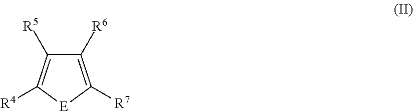
where E is an element selected from the group consisting of O, S, and NR⁸, R⁴ to R⁷ are each a hydrogen atom, a halogen atom, a cyano group, a saturated or unsaturated hydrocarbon radical having 1 to 6 carbon atoms, which may be substituted by halogen atoms, or a saturated or unsaturated alcoxy radical having 1 to 6 carbon atoms, which may be substituted by halogen atoms, where adjacent radicals R⁴ and R⁵, R⁵ and R⁶, R⁶ and R⁷ may be connected to one another so as to form a ring, and R⁸ is a hydrogen atom or a saturated or unsaturated, linear or branched hydrocarbon radical having 1 to 6 carbon atoms, which may be substituted by halogen atoms;
(4) pyridine and pyridine derivatives of the formula (III): 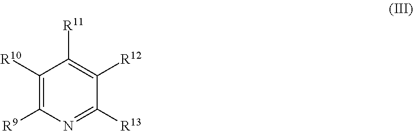
where R⁹ to R¹³ independently of one another may be selected from a hydrogen atom, a halogen atom, saturated or unsaturated, linear or branched hydrocarbon radicals having 1 to 6 carbon atoms, and cyclic, saturated or unsaturated hydrocarbon radicals having 3 to 12 carbon atoms, where adjacent hydrocarbon radicals may be connected to one another so as to form a ring;
(5) acyclic and cyclic sulfites of the general formula (IVa) and (IVb): 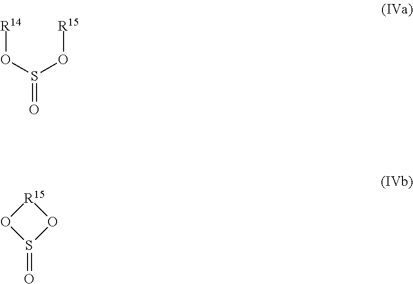
where R¹⁴ to R¹⁵ may be identical or different and are saturated or unsaturated, linear or branched hydrocarbon chains having 1 to 6 carbon atoms, and R¹⁶ is a saturated or unsaturated hydrocarbon radical having one to four carbon atoms, where R¹⁴, R¹⁵, and R¹⁶ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, where adjacent hydrocarbon radicals may be connected to one another so as to form a ring;
(6) sulfonic esters of the general formula (V): 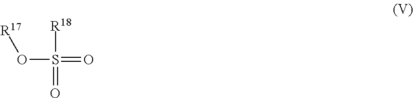
where R¹⁷ and R¹⁸ independently of one another are linear or branched, saturated or unsaturated hydrocarbon chains having 1 to 6 carbon atoms, which may optionally be substituted by halogen atoms or haloalkanes having 1 to 5 carbon atoms;
(7) sulfuric esters of the general formula (VI): 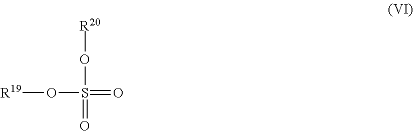
where R¹⁹ and R²⁰ independently of one another are linear or branched, saturated or unsaturated hydrocarbon chains having 1 to 6 carbon atoms, which may optionally be substituted by halogen atoms;
(8) cyclic carboxylic acid derivatives of the formula (VII): 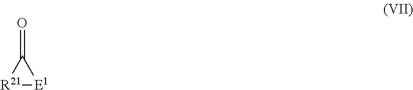
where E¹ is O or NR²⁴, R²¹ is a hydrocarbon radical having 1 to 5 carbon atoms or a group of the formula —R²²—C(O)-E²-R²³—, where R²² and R²³ each independently of one another are a hydrocarbon group having 1 to 2 carbon atoms, E² is O or NR²⁴, and each R²⁴ independently of any other is a hydrogen atom, a linear or branched, saturated or unsaturated hydrocarbon radical having 1 to 6 carbon atoms, which may optionally be substituted by halogen atoms, hydrocarbon radicals having 1 to 6 carbon atoms or radicals of the formula —C(O)R²⁵, where R²⁵ is a linear or branched, saturated or unsaturated hydrocarbon radical having 1 to 6 carbon atoms;
(9) acyclic unsaturated carboxylic acid derivatives of the general formula (VIII) 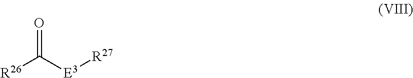
where R²⁶ is hydrogen, a halogen atom or a saturated or unsaturated, aromatic or aliphatic, linear or branched hydrocarbon radical having 1 to 12 carbon atoms, which may be substituted by halogen atoms, and R²⁷ is a saturated or unsaturated, linear or branched hydrocarbon radical having 1 to 12 carbon atoms, and E³ is O or NR²⁸, and R²⁸ and R²⁷ independently of one another have the same definition;
(10) carboxylic anhydrides and carboximides of the formulae (IXa) and (IXb): 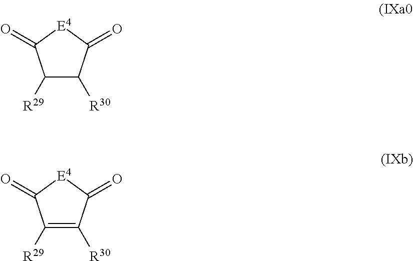
where E⁴ has the definition of O or NR³¹, R²⁹ and R³⁰ may be selected independently of one another from hydrogen atoms, halogen atoms, and linear or branched, saturated or unsaturated hydrocarbon radicals having 1 to 6 carbon atoms, which may optionally be substituted by halogen atoms, and R³¹ is a hydrogen atom or a linear or branched, saturated or unsaturated hydrocarbon radical having 1 to 6 carbon atoms;
(11) compounds of the formula (X) 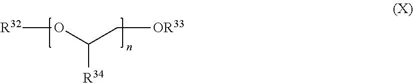
where n is an integer from 1 to 10, R³² and R³³ independently of one another are a linear or branched, saturated or unsaturated hydrocarbon radical having 1 to 6 carbon atoms, and R³⁴ is a methyl radical, an ethyl radical, an n-propyl radical or an isopropyl radical;
(12) organic nitriles of the formula (XI):
R³⁵—CN (XI)
where R³⁵ is a linear, saturated or unsaturated hydrocarbon radical having 1 to 6 carbon atoms, which may optionally be substituted by at least one cyano group;
(13) organic phosphates of the formula (XII):
(O)P(OR³⁶)(OR³⁷)(OR³⁸) (XII)
where R³⁶ to R³⁸ independently of one another are aliphatic or aromatic hydrocarbon radical having 1 to 6 carbon atoms, which may optionally be substituted by one or more halogen atoms;
(14) organic borates of the formula (XIII):
Mt[B(OR³⁹)(OR⁴⁰)(OR⁴¹)(OR⁴²)] (XIII)
where Mt is a monovalent metal cation, preferably lithium, and R³⁹ to R⁴² independently of one another are aliphatic or aromatic hydrocarbon radicals having 1 to 6 carbon atoms, which may optionally be substituted by one or more halogen atoms, or are carbonyl groups having 1 to 6 carbon atoms, which may optionally be substituted by one or more halogen atoms;
(15) organic dialkyl dicarbonates of the formula (XIV): 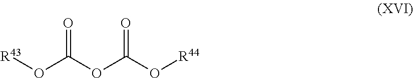
where R⁴³ and R⁴⁴ independently of one another may be selected from linear or cyclic, saturated or unsaturated hydrocarbon radicals having 1 to 6 carbon atoms;
and
(16) inorganic compounds of the formulae CO₂, N₂O, SO₂, CS₂, and Sₓ²⁻ (especially S₈²⁻),
wherein the compounds (1) to (16) may be used individually or in combination with one another.

4. The lithium-ion battery of claim 1, wherein the positive electrode (22) comprises at least one positive active material (42) which comprises a composite oxide comprising at least one metal selected from the group consisting of cobalt, magnesium, and nickel, and also lithium.

5. The lithium-ion battery of claim 4, wherein the positive active material (42) comprises a compound of the formula LiNi₁₋ₓM′ₓO₂ with x≦0.5 and where M′ is selected from Co, Mn, Cr, and Al.

6. A method for producing a lithium-ion battery comprising at least one fast discharge device (61) and at least one battery cell (2), wherein the method comprises the following steps:
(a) coating a surface of a positive and/or negative electrode (22, 21) with a coating material which comprises at least one material which has a solubility in the electrolyte composition (15) of less than 1 g/L at the lithium-ion battery operating temperature;
(b) joining together the optionally coated negative and positive electrodes (21, 22) obtained in step (a) with at least the further constituents of separator (18) and electrolyte composition (15) comprising at least one aprotic solvent and at least one lithium salt, so as to give a battery cell (2);
(c) joining together the battery cell (2) obtained in step (b) with at least one fast discharge device (61) and also, optionally, further battery cells, so as to obtain a lithium-ion battery; and
(d) charging and discharging the resulting battery at least once so as to form the lithium-ion battery.

7. The method of claim 6, wherein the electrolyte composition (15) further comprises at least one electrolyte additive selected from the following compounds (1) to (16):
(1) acyclic and cyclic carbonic esters of the general formulae (Ia) or (Ib): 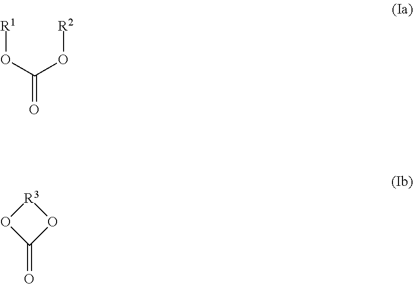
where R¹ and R² may be identical or different and are saturated or unsaturated, linear or branched hydrocarbon chains having 1 to 12 carbon atoms, R³ is a saturated or unsaturated hydrocarbon radical having one to four carbon atoms, and R¹, R², and R³ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, and where adjacent hydrocarbon radicals may be connected to one another so as to form a ring;
(2) polycyclic aromatic hydrocarbons having 9 to 30 carbon atoms, where individual aromatic rings may be connected by heteroatoms selected from O, S, and N;
(3) heterocyclic aromatic compounds of the formula (II): 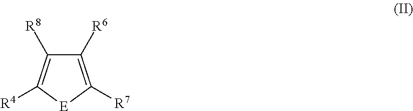
where E is an element selected from the group consisting of O, S, and NR⁸, R⁴ to R⁷ are each a hydrogen atom, a halogen atom, a cyano group, a saturated or unsaturated hydrocarbon radical having 1 to 6 carbon atoms, which may be substituted by halogen atoms, or a saturated or unsaturated alcoxy radical having 1 to 6 carbon atoms, which may be substituted by halogen atoms, where adjacent radicals R⁴ and R⁵, R⁵ and R⁶, R⁶ and R⁷ may be connected to one another so as to form a ring, and R⁸ is a hydrogen atom or a saturated or unsaturated, linear or branched hydrocarbon radical having 1 to 6 carbon atoms, which may be substituted by halogen atoms;
(4) pyridine and pyridine derivatives of the formula (III): 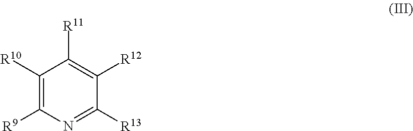
where R⁹ to R¹³ independently of one another may be selected from a hydrogen atom, a halogen atom, saturated or unsaturated, linear or branched hydrocarbon radicals having 1 to 6 carbon atoms, and cyclic, saturated or unsaturated hydrocarbon radicals having 3 to 12 carbon atoms, where adjacent hydrocarbon radicals may be connected to one another so as to form a ring;
(5) acyclic and cyclic sulfites of the general formula (IVa) and (IVb): 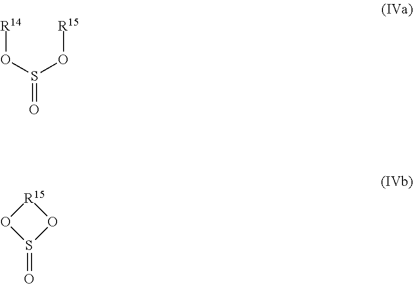
where R¹⁴ to R¹⁵ may be identical or different and are saturated or unsaturated, linear or branched hydrocarbon chains having 1 to 6 carbon atoms, and R¹⁶ is a saturated or unsaturated hydrocarbon radical having one to four carbon atoms, where R¹⁴, R¹⁵, and R¹⁶ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, where adjacent hydrocarbon radicals may be connected to one another so as to form a ring;
(6) sulfonic esters of the general formula (V): 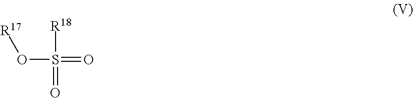
where R¹⁷ and R¹⁸ independently of one another are linear or branched, saturated or unsaturated hydrocarbon chains having 1 to 6 carbon atoms, which may optionally be substituted by halogen atoms or haloalkanes having 1 to 5 carbon atoms;
(7) sulfuric esters of the general formula (VI): 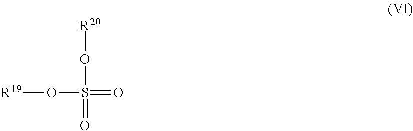
where R¹⁹ and R²⁰ independently of one another are linear or branched, saturated or unsaturated hydrocarbon chains having 1 to 6 carbon atoms, which may optionally be substituted by halogen atoms;
(8) cyclic carboxylic acid derivatives of the formula (VII): 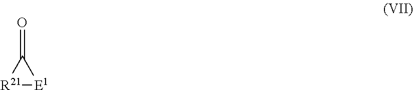
where E¹ is O or NR²⁴, R²¹ is a hydrocarbon radical having 1 to 5 carbon atoms or a group of the formula —R²²—C(O)-E²-R²³—, where R²² and R²³ each independently of one another are a hydrocarbon group having 1 to 2 carbon atoms, E² is O or NR²⁴, and each R²⁴ independently of any other is a hydrogen atom, a linear or branched, saturated or unsaturated hydrocarbon radical having 1 to 6 carbon atoms, which may optionally be substituted by halogen atoms, hydrocarbon radicals having 1 to 6 carbon atoms or radicals of the formula —C(O)R²⁵, where R²⁵ is a linear or branched, saturated or unsaturated hydrocarbon radical having 1 to 6 carbon atoms;
(9) acyclic unsaturated carboxylic acid derivatives of the general formula (VIII) 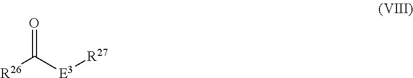
where R²⁶ is hydrogen, a halogen atom or a saturated or unsaturated, aromatic or aliphatic, linear or branched hydrocarbon radical having 1 to 12 carbon atoms, which may be substituted by halogen atoms, and R²⁷ is a saturated or unsaturated, linear or branched hydrocarbon radical having 1 to 12 carbon atoms, and E³ is O or NR²⁸, and R²⁸ and R²⁷ independently of one another have the same definition;
(10) carboxylic anhydrides and carboximides of the formulae (IXa) and (IXb): 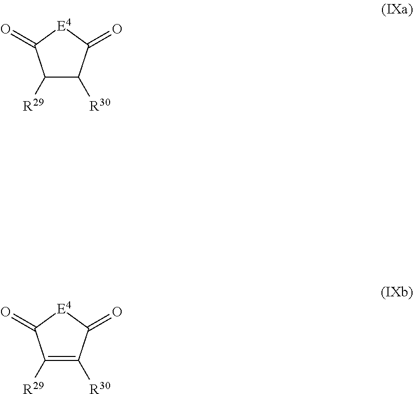
where E⁴ has the definition of O or NR³¹, R²⁹ and R³⁰ may be selected independently of one another from hydrogen atoms, halogen atoms, and linear or branched, saturated or unsaturated hydrocarbon radicals having 1 to 6 carbon atoms, which may optionally be substituted by halogen atoms, and R³¹ is a hydrogen atom or a linear or branched, saturated or unsaturated hydrocarbon radical having 1 to 6 carbon atoms;
(11) compounds of the formula (X) 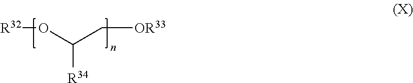
where n is an integer from 1 to 10, R³² and R³³ independently of one another are a linear or branched, saturated or unsaturated hydrocarbon radical having 1 to 6 carbon atoms, and R³⁴ is a methyl radical, an ethyl radical, an n-propyl radical or an isopropyl radical;
(12) organic nitriles of the formula (XI):
R³⁵—CN (XI)
where R³⁵ is a linear, saturated or unsaturated hydrocarbon radical having 1 to 6 carbon atoms, which may optionally be substituted by at least one cyano group;
(13) organic phosphates of the formula (XII):
(O)P(OR³⁶)(OR³⁷)(OR³⁸) (XII)
where R³⁶ to R³⁸ independently of one another are aliphatic or aromatic hydrocarbon radical having 1 to 6 carbon atoms, which may optionally be substituted by one or more halogen atoms;
(14) organic borates of the formula (XIII):
Mt[B(OR³⁹)(OR⁴⁰)(OR⁴¹)(OR⁴²)] (XIII)
where Mt is a monovalent metal cation, preferably lithium, and R³⁹ to R⁴² independently of one another are aliphatic or aromatic hydrocarbon radicals having 1 to 6 carbon atoms, which may optionally be substituted by one or more halogen atoms, or are carbonyl groups having 1 to 6 carbon atoms, which may optionally be substituted by one or more halogen atoms;
(15) organic dialkyl dicarbonates of the formula (XIV): 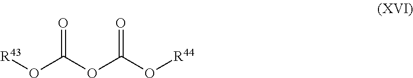
where R⁴³ and R⁴⁴ independently of one another may be selected from linear or cyclic, saturated or unsaturated hydrocarbon radicals having 1 to 6 carbon atoms;
and
(16) inorganic compounds of the formulae CO₂, N₂O, SO₂, CS₂, and Sₓ²⁻ (especially S₈²⁻),
wherein the compounds (1) to (16) may be used individually or in combination with one another.

8. A method for producing a lithium-ion battery comprising at least one fast discharge device (61) and at least one battery cell (2), wherein the method comprises the following steps:
(a) joining together the constituents of negative electrode (21), positive electrode (22), separator (18), and electrolyte composition (15), so as to give a battery cell (2), wherein the electrolyte composition (15) comprises at least one electrolyte additive selected from the following compounds (1) to (16):
(1) acyclic and cyclic carbonic esters of the general formulae (Ia) or (Ib): 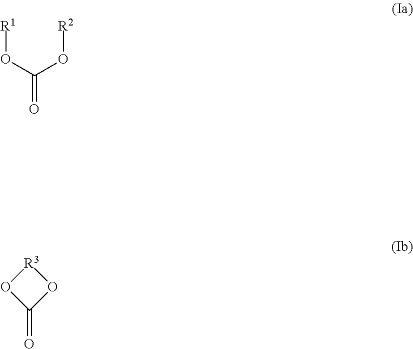
where R¹ and R² may be identical or different and are saturated or unsaturated, linear or branched hydrocarbon chains having 1 to 12 carbon atoms, R³ is a saturated or unsaturated hydrocarbon radical having one to four carbon atoms, and R¹, R², and R³ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, and where adjacent hydrocarbon radicals may be connected to one another so as to form a ring;
(2) polycyclic aromatic hydrocarbons having 9 to 30 carbon atoms, where individual aromatic rings may be connected by heteroatoms selected from O, S, and N;
(3) heterocyclic aromatic compounds of the formula (II): 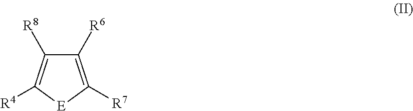
where E is an element selected from the group consisting of O, S, and NR⁸, R⁴ to R⁷ are each a hydrogen atom, a halogen atom, a cyano group, a saturated or unsaturated hydrocarbon radical having 1 to 6 carbon atoms, which may be substituted by halogen atoms, or a saturated or unsaturated alcoxy radical having 1 to 6 carbon atoms, which may be substituted by halogen atoms, where adjacent radicals R⁴ and R⁵, R⁵ and R⁶, R⁶ and R⁷ may be connected to one another so as to form a ring, and R⁸ is a hydrogen atom or a saturated or unsaturated, linear or branched hydrocarbon radical having 1 to 6 carbon atoms, which may be substituted by halogen atoms;
(4) pyridine and pyridine derivatives of the formula (III): 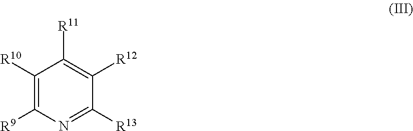
where R⁹ to R¹³ independently of one another may be selected from a hydrogen atom, a halogen atom, saturated or unsaturated, linear or branched hydrocarbon radicals having 1 to 6 carbon atoms, and cyclic, saturated or unsaturated hydrocarbon radicals having 3 to 12 carbon atoms, where adjacent hydrocarbon radicals may be connected to one another so as to form a ring;
(5) acyclic and cyclic sulfites of the general formula (IVa) and (IVb): 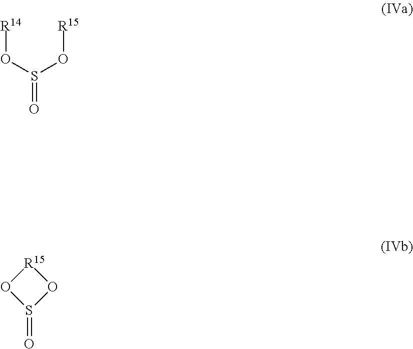
where R¹⁴ to R¹⁵ may be identical or different and are saturated or unsaturated, linear or branched hydrocarbon chains having 1 to 6 carbon atoms, and R¹⁶ is a saturated or unsaturated hydrocarbon radical having one to four carbon atoms, where R¹⁴, R¹⁵, and R¹⁶ may optionally be substituted by halogen atoms, saturated or unsaturated, linear or branched hydrocarbon radicals having 1 to 6 carbon atoms, which may be substituted by halogen atoms, or cyclic, saturated or unsaturated hydrocarbon radicals having 3 to 7 carbon atoms, which may be substituted by halogen atoms, where adjacent hydrocarbon radicals may be connected to one another so as to form a ring;
(6) sulfonic esters of the general formula (V): 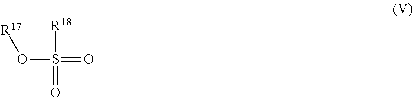
where R¹⁷ and R¹⁸ independently of one another are linear or branched, saturated or unsaturated hydrocarbon chains having 1 to 6 carbon atoms, which may optionally be substituted by halogen atoms or haloalkanes having 1 to 5 carbon atoms;
(7) sulfuric esters of the general formula (VI): 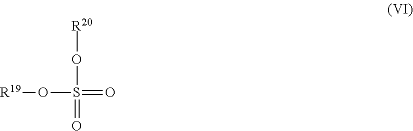
where R¹⁹ and R²⁰ independently of one another are linear or branched, saturated or unsaturated hydrocarbon chains having 1 to 6 carbon atoms, which may optionally be substituted by halogen atoms;
(8) cyclic carboxylic acid derivatives of the formula (VII): 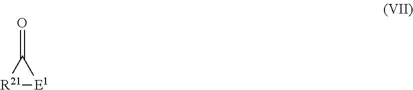
where E¹ is O or NR²⁴, R²¹ is a hydrocarbon radical having 1 to 5 carbon atoms or a group of the formula —R²²—C(O)-E²-R²³—, where R²² and R²³ each independently of one another are a hydrocarbon group having 1 to 2 carbon atoms, E² is O or NR²⁴, and each R²⁴ independently of any other is a hydrogen atom, a linear or branched, saturated or unsaturated hydrocarbon radical having 1 to 6 carbon atoms, which may optionally be substituted by halogen atoms, hydrocarbon radicals having 1 to 6 carbon atoms or radicals of the formula —C(O)R²⁵, where R²⁵ is a linear or branched, saturated or unsaturated hydrocarbon radical having 1 to 6 carbon atoms;
(9) acyclic unsaturated carboxylic acid derivatives of the general formula (VIII) 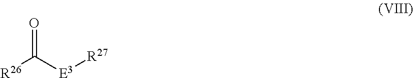
where R²⁶ is hydrogen, a halogen atom or a saturated or unsaturated, aromatic or aliphatic, linear or branched hydrocarbon radical having 1 to 12 carbon atoms, which may be substituted by halogen atoms, and R²⁷ is a saturated or unsaturated, linear or branched hydrocarbon radical having 1 to 12 carbon atoms, and E³ is O or NR²⁸, and R²⁸ and R²⁷ independently of one another have the same definition;
(10) carboxylic anhydrides and carboximides of the formulae (IXa) and (IXb): 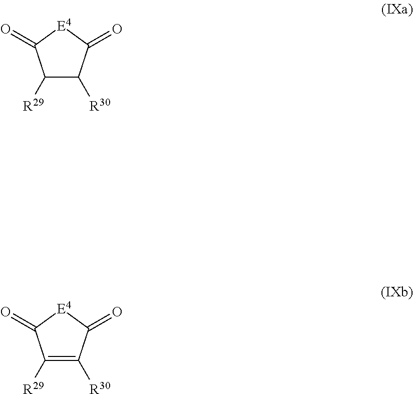
where E⁴ has the definition of O or NR³¹, R²⁹ and R³⁰ may be selected independently of one another from hydrogen atoms, halogen atoms, and linear or branched, saturated or unsaturated hydrocarbon radicals having 1 to 6 carbon atoms, which may optionally be substituted by halogen atoms, and R³¹ is a hydrogen atom or a linear or branched, saturated or unsaturated hydrocarbon radical having 1 to 6 carbon atoms;
(11) compounds of the formula (X) 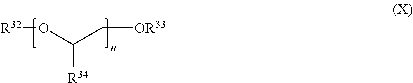
where n is an integer from 1 to 10, R³² and R³³ independently of one another are a linear or branched, saturated or unsaturated hydrocarbon radical having 1 to 6 carbon atoms, and R³⁴ is a methyl radical, an ethyl radical, an n-propyl radical or an isopropyl radical;
(12) organic nitriles of the formula (XI):
R³⁵—CN (XI)
where R³⁵ is a linear, saturated or unsaturated hydrocarbon radical having 1 to 6 carbon atoms, which may optionally be substituted by at least one cyano group;
(13) organic phosphates of the formula (XII):
(O)P(OR³⁶)(OR³⁷)(OR³⁸) (XII)
where R³⁶ to R³⁸ independently of one another are aliphatic or aromatic hydrocarbon radical having 1 to 6 carbon atoms, which may optionally be substituted by one or more halogen atoms;
(14) organic borates of the formula (XIII):
Mt[B(OR³⁹)(OR⁴⁰)(OR⁴¹)(OR⁴²)] (XIII)
where Mt is a monovalent metal cation, preferably lithium, and R³⁹ to R⁴² independently of one another are aliphatic or aromatic hydrocarbon radicals having 1 to 6 carbon atoms, which may optionally be substituted by one or more halogen atoms, or are carbonyl groups having 1 to 6 carbon atoms, which may optionally be substituted by one or more halogen atoms;
(15) organic dialkyl dicarbonates of the formula (XIV): 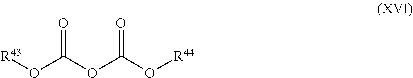
where R⁴³ and R⁴⁴ independently of one another may be selected from linear or cyclic, saturated or unsaturated hydrocarbon radicals having 1 to 6 carbon atoms; and
(16) inorganic compounds of the formulae CO₂, N₂O, SO₂, CS₂, and Sₓ²⁻ (especially S₈²⁻),
wherein the compounds (1) to (16) may be used individually or in combination with one another;
(b) joining together the battery cell (2) obtained in step (a) with at least one fast discharge device (61) and also, optionally, further battery cells (2) so as to give a lithium-ion battery; and
(c) charging and discharging the resulting battery at least once, so as to form the lithium-ion battery and thus to form a coating layer on the surface of the positive and/or negative electrode (22, 21), this layer comprising electrochemical reaction products of the compounds (1) to (16) added in step (a).
